(19) United States
(12) Patent Application Publication
(10) Pub. No.: US 2009/0231568 A1
(43) Pub. Date: Sep. 17, 2009

(54) METHOD OF MEASURING WAVEFRONT ERROR, METHOD OF CORRECTING WAVEFRONT ERROR, AND METHOD OF FABRICATING SEMICONDUCTOR DEVICE

(76) Inventor: Kazuya Fukuhara, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/400,701

(22) Filed: Mar. 9, 2009

(30) Foreign Application Priority Data
Mar. 12, 2008 (JP) 2008-062885

(51) Int. Cl. G03B 27/52; G01B 11/00

(52) U.S. Cl. 355/67; 356/124

(57) ABSTRACT

A method of measuring a wavefront error of an exposure light that occurs when the exposure light passes through an optical system that is used in an exposure apparatus is proposed. The method includes measuring the wavefront error of the exposure light by using a measurement optical element including a pellicle arranged in an optical path of the exposure light that passes through the optical system.

### CROSS-REFERENCE TO RELATED APPLICATIONS

This application is based upon and claims the benefit of priority from the prior Japanese Patent Application No. 2008-062885, filed on Mar. 12, 2008; the entire contents of which are incorporated herein by reference.

### BACKGROUND OF THE INVENTION

1. Field of the Invention

The present invention relates to a method of measuring a wavefront error, a method of correcting the wavefront error, and a method of fabricating a semiconductor device. The present invention more particularly relates to a technology for measuring a wavefront error that occurs in an optical system of an exposure apparatus.

2. Description of the Related Art

In the course of fabricating a semiconductor device by using the technique of photolithography, an exposure apparatus is used to transfer a mask pattern that is formed on a reticle onto a process object such as a wafer on which a resist is formed. The exposure apparatus is required to project the mask pattern in a high-resolution and at high-precision. Various factors such as wavefront error (i.e., wavefront aberration) affect imaging properties of a projection optical system. The wavefront error may disadvantageously shift a focus position depending on, for example, density of the mask pattern. If the focus position is shifted, it is difficult to project the mask pattern that is formed on the reticle in the high-resolution and high-precision manner. JP-A 2002-250677 (KOKAI), for example, discloses a technology that makes it is possible to accurately measure the wavefront error of the projection optical system.

A typical reticle includes a pellicle as a dust prevention film so that an image of dust that is attached to the mask pattern cannot be focused on the process object. The pellicle is a film made of a material transparent to an exposure light. A phase of the light that passes through the pellicle changes depending on film thickness, refractive index of the material of the pellicle, and incident angle of the light. To satisfy needs for improvement in precision and integration of the pattern that is formed on the semiconductor device, there has been a trend toward using a projection optical system having a larger numerical aperture in the exposure apparatuses that are used to fabricate the semiconductor device. As the numerical aperture of the projection optical system increases, the wavefront error occurring due to the pellicle increases. The effect of the wavefront error becomes remarkable when, for example, the numerical aperture is 1 or larger, specifically, about 1.3 or larger. Even if the wavefront error resulting from the projection optical system is corrected accurately, the presence of the pellicle can makes it difficult to project the pattern formed on the reticle in the high-resolution and the high-precision manner.

### BRIEF SUMMARY OF THE INVENTION

According to an aspect of the present invention there is provided a method of measuring a wavefront error of an exposure light that occurs when the exposure light passes through an optical system that is used in an exposure apparatus. The method includes measuring the wavefront error of the exposure light by using a measurement optical element including a pellicle arranged in an optical path of the exposure light that passes through the optical system.

According to another aspect of the present invention there is provided a method of correcting a wavefront error of an exposure light that occurs when the exposure light passes through an optical system that is used in an exposure apparatus. The method includes acquiring a third wavefront error as a combined error of a first wavefront error and a second wavefront error, the first wavefront error being a wavefront error occurring due to a projection optical system that is used to project an image having a predetermined pattern, and the second wavefront error being a wavefront error occurring due to a pellicle that is arranged in an optical path of the exposure light; and adjusting the projection optical system based on the third wavefront error.

According to still another aspect of the present invention there is provided a method of fabricating a semiconductor device by projecting an image having a predetermined pattern that is formed on a reticle onto a process object via a pellicle that is arranged on the reticle and a projection optical system. The method including acquiring a third wavefront error as a combined error of a first wavefront error and a second wavefront error, the first wavefront error being a wavefront error occurring due to the projection optical system, and the second wavefront error being a wavefront error occurring due to the pellicle; and adjusting the projection optical system based on the third wavefront error.

### BRIEF DESCRIPTION OF THE DRAWINGS

FIG. 1 is a schematic diagram of an exposure apparatus with which a method of fabricating a semiconductor device according to a first embodiment is performed;

FIG. 2 is a cross-sectional view of a reticle shown in FIG. 1;

FIG. 3 is a schematic diagram of relevant parts of a wavefront sensor shown in FIG. 1;

FIG. 4 is a cross-sectional view of a measurement blank;

FIG. 5 is a schematic diagram for explaining behavior of an exposure light passing through a pellicle that is formed on the reticle;

FIG. 6 is a flowchart of a process of correcting a wavefront error;

FIG. 7 is a schematic diagram of an arrangement of the exposure apparatus to measure the wavefront error;

FIG. 8 is a flowchart of a process of fabricating the semiconductor device;

FIG. 9 is a flowchart of a process of correcting the wavefront error according to a second embodiment;

FIG. 10 is a flowchart of an exposure process that is a part of a process of fabricating the semiconductor device according to a third embodiment;

FIG. 11 is a graph of a relation among transmittance, incident angle, and thickness of the pellicle; and

FIG. 12 is a schematic diagram for explaining calculation for properties of the pellicle.

### DETAILED DESCRIPTION OF THE INVENTION

Exemplary embodiments of a method of measuring a wavefront error, a method of correcting the wavefront error, and a method of fabricating a semiconductor device are described below while referring to the accompanying drawings. The present invention is not limited to the embodiments explained below.

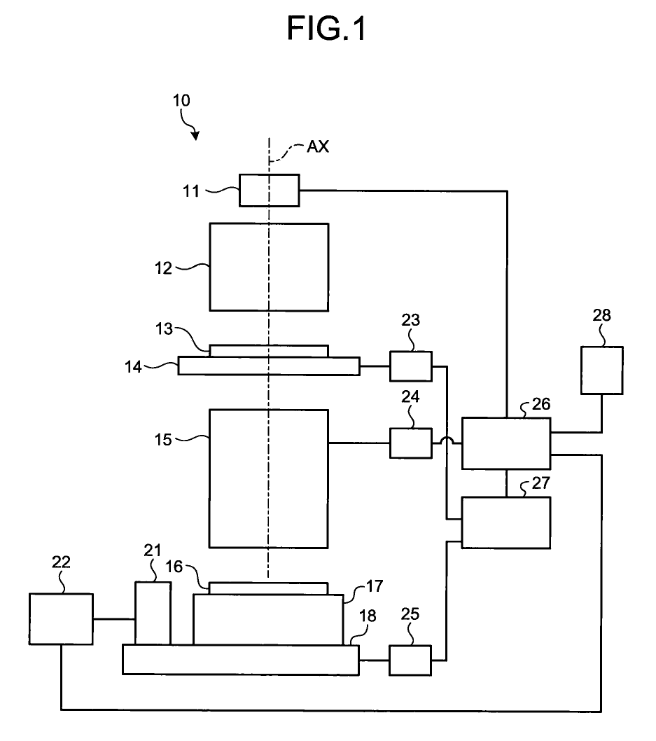

FIG. 1 is a schematic diagram of an exposure apparatus 10 with which a method of fabricating a semiconductor device according to a first embodiment of the present invention is performed. The exposure apparatus 10 transfers a mask pattern that is formed on a reticle 13 onto a process object 16 by exposure via the reticle 13. The exposure apparatus 10 is a reduction-projection exposure apparatus. That is, in the exposure apparatus 10, an image having the pattern that is formed on the reticle 13 is reduced and the reduced image is projected by using a projection lens 15. The exposure apparatus 10 includes a main unit and a wavefront measuring device. The main unit includes a light source 11, an illumination optical system 12, a reticle stage 14, the projection lens 15, a wafer stage 18, and a control system (including a main control unit 26). Assume that an optical axis AX is the central axis of both the illumination optical system 12 and the projection lens 15.

The light source 11 emits, for example, an ultraviolet pulse light as an exposure light. The light source 11 can be, for example, an excimer-laser light source that emits an ArF excimer laser, a KrF excimer laser, or the like. The illumination optical system 12 illuminates the reticle 13 with the exposure light emitted from the light source 11. The illumination optical system 12 includes, although not shown, a homogenization optical system, a reticle blind, and a light-collection optical system. The homogenization optical system homogenizes the intensity of the light received from the light source 11. The reticle blind determines the exposure target area on the reticle 13 that is to be exposed with the exposure light. The light-collection optical system collects the exposure light. The illumination optical system 12 can include, for example, a polarizer that polarizes the exposure light to a predetermined polarization state and a mirror to bend an optical path.

The reticle stage 14 supports the reticle 13 by, for example, vacuum contact. A reticle-stage driving unit 23 is operative to move the reticle stage 14 in a movable area. The current position of the reticle stage 14 within the movable area is continuously detected by a detection unit (not shown). Positional data indicating the current position of the reticle stage 14 is sent to the main control unit 26 via a stage control unit 27. The main control unit 26 causes the stage control unit 27 and the reticle-stage driving unit 23 to move the reticle stage 14 based on the positional data. By the movement of the reticle stage 14, replacement between the reticle 13 and a measurement blank 50 at a position on the optical axis AX is performed.

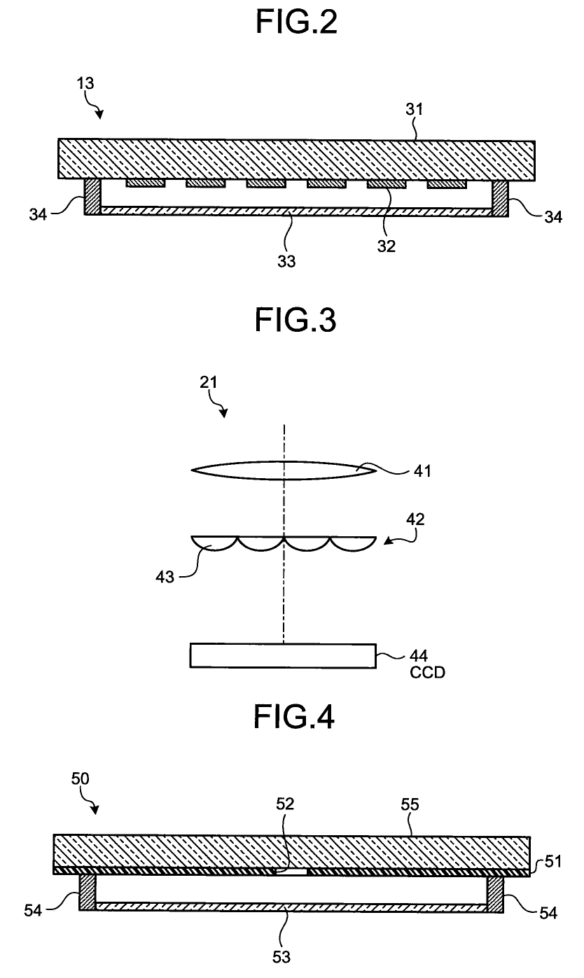

FIG. 2 is a cross-sectional view of the reticle 13. The reticle 13 includes a plurality of mask patterns 32 made of, for example, a chromium oxide film or a chromium film. The mask patterns 32 are formed on an exit surface of a glass substrate 31. An exit surface of a member, e.g., the glass substrate 31, is a surface from where light exits the member. The glass substrate 31 is made of a material transparent to the exposure light, for example, quartz. A pellicle film 33 is formed on the glass substrate 31 to cover the mask patterns 32. A pellicle frame 34 is formed surrounding the pellicle film 33. The pellicle frame 34 is, for example, 5 mm in height. A pellicle includes the pellicle film 33 and the pellicle frame 34.

The pellicle film 33 works as a protection film that protects the mask patterns 32 from dust. The pellicle film 33 is a film made of a material that is transparent to the exposure light. In the present embodiment, the pellicle film 33 is made of, for example, a fluorine-based polymer that is transparent to the exposure light emitted from the light source 11. Moreover, the pellicle film 33 is formed such that transmittance of the exposure light to the pellicle film 33 that enters the pellicle film 33 at the right angle becomes close to the maximum. In other words, for example, the pellicle film 33 is formed such that its refractive index is about 1.40, and layer thickness is about 830 nanometers. When the process object 16 is exposed with the exposure light received from the illumination optical system 12, the reticle 13 is arranged in such a manner that the plane of the exposure light and the plane of the mask patterns 32 match. Moreover, an entrance surface of the glass substrate 31 and an exit surface of the pellicle film 33 are inclined to the plane on which the exposure light received from the illumination optical system 12 is focused. An entrance surface of a member, for example, the glass substrate 31, is a surface from where light enters the member. Due to this, even if dust is present on the entrance surface of the glass substrate 31 or the exit surface of the pellicle film 33, an adverse effect of this dust on the imaging of the mask patterns 32 can be suppressed.

Referring back to FIG. 1, the projection lens 15 is arranged in a position where it can receive the exposure light coming out of the reticle 13. The projection lens 15 is a projection optical system that projects the image of the mask patterns 32 that is present on the reticle 13. Projection magnification of the projection lens 15 is, for example, ¼, ⅕, and ⅙. The projection lens 15 includes a plurality of lens elements that are arranged on the optical axis AX. Optical adjustment, such as interval adjustment among the lens elements and eccentricity adjustment, is performed by appropriately moving one or more of the lens elements. The imaging properties of the projection lens 15 can be adjusted to desired imaging properties by performing such optical adjustment.

The projection lens 15 includes a plurality of driving elements for moving the lens elements. The driving elements can be, for example, piezoelectric elements. The driving elements can independently move each of the lens elements. The driving elements move the lens elements, for example, in a direction parallel to the optical axis AX. The lens elements can be configured to, for example, be inclinable in a plane that is perpendicular to the optical axis AX, in addition to be movable in the direction parallel to the optical axis AX. An imaging-property correcting controller 24 controls driving of the driving elements based on a signal received from the main control unit 26. The main control unit 26 adjusts the imaging properties of the projection lens 15, such as distortion, curvature of field, astigmatism, comatic aberration, and spherical aberration, by causing the imaging-property correcting controller 24 to appropriately move the lens elements.

A wafer holder 17 is fixed on the wafer stage 18. The wafer holder 17 firmly holds the process object 16 by, for example, the vacuum contact. A wafer-stage driving unit 25 moves the wafer stage 18 in a plane perpendicular to the optical axis AX. Moreover, the wafer-stage driving unit 25 inclines the wafer holder 17 in the plate perpendicular to the optical axis AX, or moves the wafer holder 17 in a direction parallel to the optical axis AX. A position of the wafer stage 18 within a movable area and a position of the wafer holder 17 within a movable area are always detected by a detection unit (not shown). Positional data indicative of the current position of the wafer holder 17 and the wafer stage 18 are sent to the main control unit 26 via the stage control unit 27. The main control unit 26 causes the stage control unit 27 and the wafer-stage driving unit 25 to move the wafer stage 18 and the wafer holder 17 based on the positional data about the wafer stage 18 and the wafer holder 17. The process object 16 is a substrate as a wafer on which a resist is formed. The wafer is made of, for example, silicon. By the movement of the wafer stage 18, replacement between the process object 16 and a wavefront sensor 21 at a position on the optical axis AX can be performed.

The main control unit 26 includes a CPU, a ROM, and a RAM, and controls the exposure apparatus 10. For example, an external storage device 28 including a hard disk is connected to the main control unit 26. The external storage device 28 stores therein results of measurement by the wavefront measuring device and data that is calculated from the results of measurement. The waveform measuring device includes the wavefront sensor 21 and a wavefront-data processing unit 22. The wavefront sensor 21 is arranged on the wafer stage 18.

FIG. 3 is a schematic diagram of relevant parts of the wavefront sensor 21. The wavefront sensor 21 includes a collimator lens 41, a lens array 42, and a CCD 44. The CCD 44 is an imaging device including a plurality of light-receiving elements arranged in a matrix. The process object 16 is replaced with the wavefront sensor 21 by the movement of the wafer stage 18. When the wavefront sensor 21 receives the light, the collimator lens 41 converts the light into a parallel light. The lens array 42 includes a plurality of lens elements 43 arranged in a matrix within a plane perpendicular to the optical axis AX. The lens elements 43 focus the received light onto the light-receiving elements of the CCD 44. The wavefront sensor 21 can be configured to include one or more mirrors to bend the optical path, or one or more relay lenses.

Referring back to FIG. 1, the wavefront-data processing unit 22 calculates the wavefront error of the optical systems in the exposure apparatus 10 by using the result of imaging by the CCD 44. The external storage device 28 stores therein data about the wavefront error that is calculated by the wavefront-data processing unit 22. The main control unit 26 drives the imaging-property correcting controller 24 based on the data about the wavefront error stored in the external storage device 28. Any method of exposure can be used by the exposure apparatus 10, such as the step-and-repeat or the step-and-scan. The exposure apparatus 10 can be a liquid-immersion exposure apparatus in which a space between the projection lens 15 and the process object 16 is filled with liquid, for example, water.

FIG. 4 is a cross-sectional view of the measurement blank 50. The measurement blank 50 is arranged in the optical path of the exposure light when measuring the wavefront error. The measurement blank 50 is placed in place of the reticle 13 by the movement of the reticle stage 14. The measurement blank 50 includes an aperture plate 51 having an aperture 52. The aperture plate 51 is formed on an exit surface of a transparent substrate 55 as a light-shielding member. Only a part of the exposure light entering the aperture 52 can pass through the aperture plate 51. The measurement blank 50 is arranged in such a manner that both an entrance surface and an exit surface of the aperture plate 51 are perpendicular to the optical axis AX. Moreover, the measurement blank 50 is arranged in such a manner that the plane of the exposure light coming from the illumination optical system 12 matches with the exit surface of the aperture plate 51.

A measurement pellicle film 53 is a pellicle that is provided to the measurement blank 50. The pellicles used in the embodiments are made of the same material and have the same structure as a typical pellicle that is formed on a typical reticle. The function of the pellicles is not limited to protection of the mask patterns from dust. The measurement pellicle film 53 is formed on the exit surface of the aperture plate 51. The measurement pellicle film 53 is formed in the same manner as the pellicle film 33 according to the present embodiment (see FIG. 2) is formed on the reticle 13.

The measurement pellicle film 53 is made of, in the same manner as the pellicle film 33 that is formed on the reticle 13, a material that is transparent to the exposure light emitted from the light source 11, for example, a fluorine-based polymer. Moreover, the measurement pellicle film 53 is formed, in the same manner as the pellicle film 33 is formed on the reticle 13, so that the refractive index is, for example, about 1.40 and the layer thickness is, for example, about 830 nanometers. The measurement blank 50 includes a pellicle frame 54 surrounding the measurement pellicle film 53, in the same manner as the reticle 13 includes. After passing through the aperture 52, the exposure light passes through the measurement pellicle film 53 and then exits the measurement blank 50. The measurement blank 50 can be configured to have a mask pattern for measurement of the wavefront error.

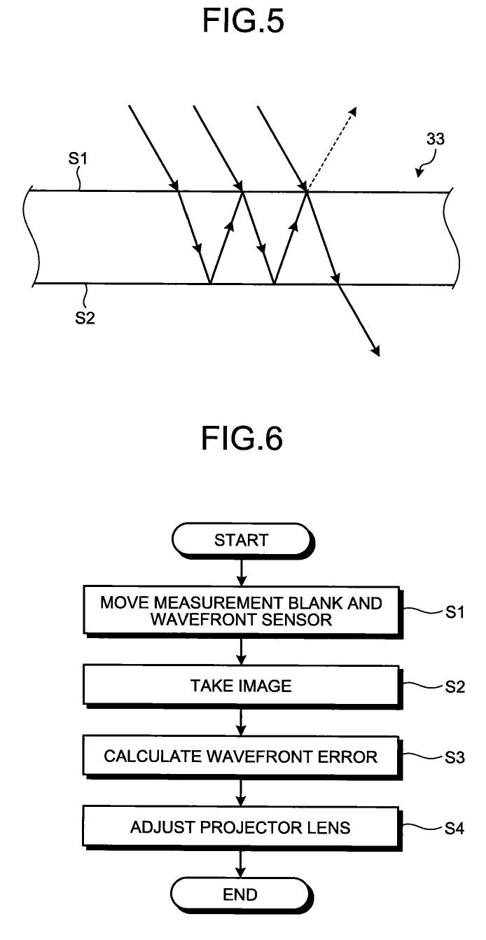

FIG. 5 is a schematic diagram for explaining the behavior of the exposure light when the exposure light passes through the pellicle film 33 that is formed on the reticle 13. Assume that the pellicle film 33 is made of a material having the refractive index different from that of a surrounding air layer. Due to this, a part of the light that enters the pellicle film 33 from a first surface S1 is reflected by a second surface S2, which is opposite to the first surface S1, toward the first surface S1. The other part of the light that enters from the first surface S1 exits the pellicle film 33 from the second surface S2. A part of the reflected light that is reflected by the second surface S2 is further reflected by the first surface S1; and the reflected light goes toward the second surface S2. The other part of the reflected light that is reflected from the first surface S1 to the second surface S2 goes out of the pellicle film 33 from the first surface S1. The pellicle film 33 outputs an overlapped light as a result of the multiple reflections between the first surface S1 and the second surface S2.

Assume that an angle between the incident light that fall on the pellicle film 33 and the optical axis AX is an incident angle. The reflectance of the first surface S1 and the reflectance of the second surface S2 depend on this incident angle. In the exposure apparatus 10, the incident angle of the exposure light to the reticle 13 is up to, for example, about 20 degrees. The larger the incident angle is, the higher the reflectance of the first surface S1 and the reflectance of the second surface S2 become. The phase of the components of the light that goes out from the second surface S2 varies depending on the number of reflections between the first surface S1 and the second surface S2. Thus, the thickness of the pellicle film 33 affects the phase. In this manner, the phase of the light that goes out of the pellicle film 33 from the second surface S2 varies depending on the thickness of the pellicle film 33, the refractive index of the material making the pellicle film 33, and the incident angle of the incident light.

The smaller the wavefront error, which is deviation between a real wavefront of the exposure light and a spherical ideal wavefront, on an entrance surface of the process object 16 is, the higher-resolution image can be projected through the projection lens 15. The change in the phase of the exposure light that occurs in the pellicle film 33 depending on the incident angle acts in the same manner as the aberration that occurs in the lenses acts. In other words, the change in the phase that occurs due to the presence of the pellicle film 33 may increase the wavefront error. Because the change in the phase that occurs in the pellicle film 33 depends on the incident angle of the exposure light, the wavefront error that occurs due to the pellicle film 33 increases as the NA of the projection lens 15 increases. The larger the wavefront error is, to the larger extent the properties at which the dimension error of each pattern becomes the minimum value (hereinafter “best-focus properties”) change. This change decreases the depth at which the images of the mask patterns 32 focus. As a result, even the wavefront error due to the projection lens 15 is corrected extremely precisely, it is difficult to project the patterns formed on the reticle 13 in the high-resolution and high-precision manner.

FIG. 6 is a flowchart of a process of correcting the wavefront error according to the first embodiment. The measurement blank 50 is moved onto the optical axis AX within the optical path of the exposure light by the movement of the reticle stage 14 (Step S1). The wavefront sensor 21 is also moved onto the optical axis AX by the movement of the wafer stage 18.

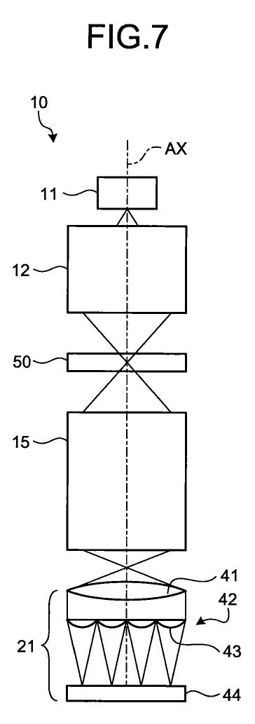

FIG. 7 is a schematic diagram of an arrangement of the exposure apparatus 10 when measuring the wavefront error. Only relevant parts of the exposure apparatus 10 are illustrated in FIG. 7. The measurement blank 50 is arranged in such a manner that the aperture 52 of the aperture plate 51 (see FIG. 4) is on the optical axis AX. The wavefront sensor 21 is arranged in such a manner that the center axis of the collimator lens 41 coincides with the optical axis AX. When the exposure light coming from the illumination optical system 12 enters the measurement blank 50, a spherical wave almost in the shape of the ideal wavefront generates at the aperture 52 of the measurement blank 50. The collimator lens 41 converts the spherical wave into a parallel light. If there is a wavefront error due to the measurement pellicle film 53 or a wavefront error due to the projection lens 15, the spherical wave is deformed due to the wavefront error before entering the collimator lens 41. The parallel light output from the collimator lens 41 enters the lens elements 43 of the lens array 42, and is focused on the light-receiving elements of the CCD 44.

Imaging by the CCD 44 is performed at Step S2. The CCD 44 detects a brightness distribution on the imaging surface by using the light-emitting elements. The wavefront error of the optical systems in the exposure apparatus 10 is calculated from the result of imaging by the CCD 44 (Step S3). The calculated wavefront error is a third wavefront error that is a combined wavefront error of a first wavefront error due to the projection lens 15 and a second wavefront error due to the measurement pellicle film 53. The third wavefront error is acquired at Step S3. Because the wavefront error is calculated where the measurement blank 50 including the measurement pellicle film 53 is arranged in the optical path of the exposure light, it is possible to extremely precisely measure the wavefront error that occurs in the optical systems of the exposure apparatus 10 including the measurement pellicle film 53.

The optical adjustment of the projection lens 15 is performed based on data about the third wavefront error (Step S4). The projection lens 15 is adjusted to the optimum state such that, for example, an aberration root mean square (aberration RMS), which represents an average of the gap between the ideal wavefront and the real wavefront, becomes the smallest value. Thus, the process of the correction of the wavefront error that occurs in the optical systems of the exposure apparatus 10 goes to end. In this manner, the wavefront error that occurs in the optical systems of the exposure apparatus 10 can be corrected extremely precisely. The correction of the wavefront error according to the first embodiment is performed, for example, at installation of the exposure apparatus 10, or periodically after the installation of the exposure apparatus 10.

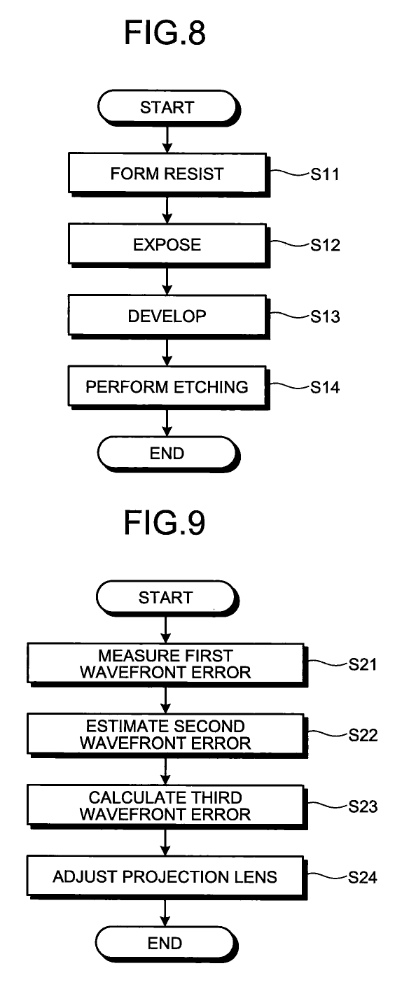

FIG. 8 is a flowchart of a process of fabricating the semiconductor device according to the first embodiment. The resist is formed by applying a photosensitizer onto the wafer (Step S11). The process object 16 is exposed by using the exposure apparatus 10 in which the wavefront error is corrected as in the manner described with reference to FIG. 6 (Step S12). More particularly, the image based on a pattern that is formed on the reticle 13 is projected onto the process object 16 via the pellicle film 33 and the projection lens 15 (Step S12). Because the exposure apparatus 10 in which the wavefront error is corrected extremely precisely is used, it is possible to project the pattern that is formed on the reticle 13 in the high-resolution and high-precision manner.

The process object 16 that has been exposed at Step S12 is then developed (Step S13). After that, unnecessary resist is removed from the process object 16 by etching (Step S14). Those steps are repeated, and thus some patterns are overlapped on the wafer. After the patterned wafer is subjected to various subsequent steps, the semiconductor-device fabricating process goes to end. It is possible to boost the yield of the semiconductor device by increasing the resolution and the precision at which the pattern formed on the reticle 13 is projected.

The thickness of the pellicle film 33 that is formed on the reticle 13 can be set to any appropriate value. The thickness of the measurement pellicle film 53 that is formed the measurement pellicle film 53 is set to equal to the thickness of the pellicle film 33 that is formed on the reticle 13. It is permissible that the thickness of the pellicle film 33 is set to such a value that, for example, when the wavefront error due to the pellicle film 33 is expanded by using Zernike expansion, a ratio of components of the RMS represented by terms having the Zernike order of 10 or higher to components of the RMS represented by terms having the Zernike order of 5 or higher is lower than 10%. The Zernike expansion is an expansion by using Zernike polynomials (see, for example, JP-A 2002-250677 (KOKAI)). More particularly, if there are various components representing the spherical aberration including 4(Z₄), 9(Z₉), 16(Z₁₆), 25(Z₂₅), and 36(Z₃₆) with respect to the Zernike order, the thickness of the pellicle film 33 can be decided to such a value that the high-ordered components, such as the components of Z₁₆, Z₂₅, and Z₃₆, are close to zero, i.e., the absolute values of the components decreases as possible.

In the field of projection lenses that have been widely used, it is easy to correct the low-ordered aberration components (e.g., Z₄ and Z₉) efficiently, while it is difficult to correct the high-ordered aberration components (e.g., Z₁₆, Z₂₅, and Z₃₆). If the thickness of the pellicle film 33 is adjusted to the value at which the absolute values of the difficult-to-correct components decreases as possible, it is possible to decrease the spherical aberration to a larger extent by the optical adjustment of the projection lens 15. For example, taking it into consideration that the absolute value of the component of Z₁₆ is likely to be larger than the absolute values of the other high-ordered components of Z₂₅ and Z₃₆, the thickness of the pellicle film 33 is decided to such a value that the absolute value of the component of Z₁₆ becomes the smallest. If the absolute value of the component of Z₁₆ is the smallest when the thickness of the pellicle film 33 is 822 nm, then the thickness is decided to 822 nm. It can be configured to make such a decision about the thickness of the pellicle film 33 only when the NA of the projection lens 15 is equal to or larger than 1.

Moreover, it is allowable to adjust the projection lens 15 in such a manner that the absolute value of the component of Z₉, from among the components representing the wavefront error due to the pellicle film 33, is the smallest. It can be configured to make the adjustment of the projection lens 15 for obtaining the smallest absolute value of the component of Z₉, only when the numerical aperture of the projection lens 15 is equal to or larger than 1. Thus, the wavefront error that occurs in the optical systems of the exposure apparatus 10 decreases effectively. It is allowable to use, for the calculation for deciding the thickness of the pellicle film 33, an average value of the wavefront error where an s-polarized light is used as the incident light to the pellicle film 33 and the wavefront error where a p-polarized light is used as the incident light. In this case, the wavefront error is decreased by an averaged value between when the s-polarized light is used and when the p-polarized light is used.

FIG. 9 is a flowchart of a process of correcting the wavefront error according to a second embodiment of the present invention. It is assumed that the exposure apparatus 10 is used to implement the second embodiment. The first wavefront error, which is the wavefront error due to the projection lens 15, is measured at Step S21. More particularly, the measurement blank 50 used in the first embodiment from which the measurement pellicle film 53 and the pellicle frame 54 are excluded is used as the measurement blank at Step S21.

After that, the second wavefront error, which is the wavefront error due to the pellicle film 33 that is formed on the reticle 13, is estimated at Step S22. More particularly, the second wavefront error is calculated at Step S22 based on the properties of the pellicle film 33, for example, the film thickness and the optical coefficients (e.g., the refractive index and the extinction coefficient). That is, the second wavefront error due to the pellicle film 33 that is expected to occur when the pellicle film 33 having the predetermined properties is arranged in the optical path of the exposure light within the exposure apparatus 10 is calculated at Step S22. In this second wavefront error calculation, the thickness of the pellicle film 33 is used as a parameter, assumed that the film thickness is, for example, an average value of a range of a manufacturing error.

The third wavefront error is calculated by combining the first wavefront error measured at Step S21 and the second wavefront error calculated at Step S22, at Step S23. The optical adjustment of the projection lens 15 is performed based on data about the third wavefront error that is calculated at Step S23, at Step S24. The projection lens 15 is adjusted, in the same manner as in the first embodiment, to the optimum state such that, for example, the aberration RMS becomes the smallest value.

In the second embodiment, the wavefront error that occurs in the optical systems of the exposure apparatus 10 can be corrected extremely precisely. Moreover, the drop in the wavefront error for various reticles 13 is averaged by calculating the wavefront error from data representing the averaged properties of the reticle 13 and correcting the calculated wavefront error. This makes it possible to achieve a high-resolution and high-precision projection by the exposure apparatus 10. With this configuration, the yield of the semiconductor device that is fabricated through the exposure performed by the exposure apparatus 10 improves. The correction of the wavefront error can be performed every replacement of the reticle 13 including the pellicle film 33 having different properties. This makes it possible to correct the wavefront error extremely precisely by adjusting the properties of the pellicle film 33.

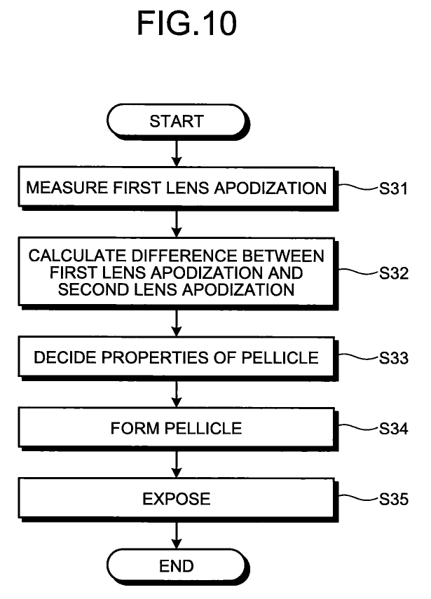

FIG. 10 is a flowchart of an exposure process that is a part of a process of fabricating the semiconductor device according to a third embodiment of the present invention. It is assumed that the exposure apparatus 10 is used to implement the third embodiment. The salient feature of the third embodiment is to decide the properties of the pellicle film 33 based on a lens apodization of the projection lens 15 that is the optical property of the exposure apparatus 10. The lens apodization is mainly caused by fluctuation in the properties of the materials making the lens and processing accuracy on the surface. The lens apodization is a phenomenon that the light intensity is attenuated unevenly so that a drop in the light intensity changes depending on the optical path of the light passing through the lens.

As described in the first embodiment with reference to FIG. 5, the pellicle film 33 causes the phase of the light to change by the multiple reflections between the first surface S1 and the second surface S2. As for the components of the light output from the second surface S2, not only the phase but also the intensity changes according to the number of the reflections between the first surface S1 and the second surface S2. In other words, the pellicle film 33 causes the phase and the intensity of the light to change by the multiple reflections. When the light exits from the second surface S2 of the pellicle film 33, the intensity of this light changes depending on the thickness of the pellicle film 33, the refractive index of the material making the pellicle film 33, and the incident angle of the incident light.

The change in the intensity of the light depending on the incident angle of the exposure light acts in the same manner as the lens apodization acts. More particularly, the presence of the pellicle film 33 formed on the reticle 13 causes not only the wavefront error, as described in the first embodiment, but also the change in the lens apodization. The change in the lens apodization may cause a change in the image intensity depending on the density of the mask patterns 32, etc. The larger the numerical aperture of the projection optical system is, to the larger extent the lens apodization due to the pellicle film 33 changes.

The lens apodization of the projection lens 15 of the exposure apparatus 10 (hereinafter, “first lens apodization”) is measured at Step S31 illustrated in FIG. 10. The lens apodization of the projection lens 15 is an optical property of the exposure apparatus 10, and is called “first optical property”. The first optical property is acquired by the measurement at Step S31. More particularly, the lens apodization is measured by using a light that is polarized in the same manner as the exposure light to be used for the exposure by the exposure apparatus 10, at Step S31. When measuring the lens apodization, the exposure apparatus 10 is arranged, for example, almost as illustrated in FIG. 7 except that the wavefront sensor 21 is replaced by a CCD camera.

A difference between the first lens apodization and a second lens apodization is calculated as a difference in the transmittance distributions (hereinafter, “difference distribution”). The second lens apodization is a target lens apodization, for example, a lens apodization of the exposure apparatus based on an optical proximity correction (OPC) model. The second lens apodization is a target optical property of the exposure apparatus 10, and is called “second optical property”. The difference between the first optical property representing the first lens apodization and the second optical property representing the second lens apodization is acquired at Step S32.

The properties of the pellicle film 33 are decided based on the difference acquired at Step S32, at Step S33. More particularly, such properties are calculated that the difference distribution calculated at Step S32 is offset to almost zero by the change in the transmittance distribution due to the pellicle film 33. The dependence of the transmittance of the pellicle film 33 on the incident angle can be controlled by adjusting the optical coefficients and the thickness of the pellicle film 33 to appropriate values.

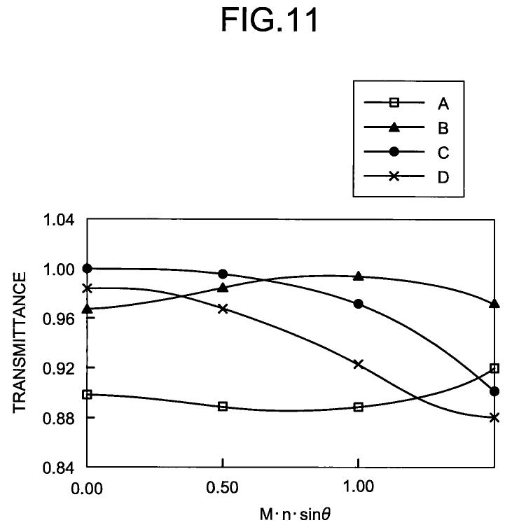

FIG. 11 is a graph of a relation among transmittance of the pellicle film 33, incident angle of the light to the pellicle film 33, and thickness of the pellicle film 33. The vertical axis represents the transmittance; the horizontal axis represents a parameter M·n·sin θ, where M is magnification of the projection lens 15, n is refractive index of the medium between the projection lens 15 and the process object 16, and θ is incident angle of the light to the pellicle film 33. Assume, for example, that the magnification M of the projection lens 15 is ¼ and the medium between the projection lens 15 and the process object 16 is water. A curve line A in the figure is the transmittance distribution where the thickness of the pellicle film 33 is 730 nanometers; a curve line B is for the thickness of 770 nanometers; a curve line C is for the thickness of 830 nanometers; and a curve line D is for the thickness of 890 nanometers.

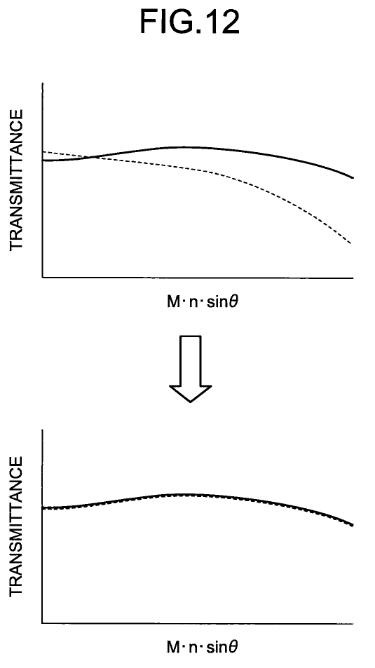

FIG. 12 is a schematic diagram for explaining the calculation for the properties of the pellicle film 33. A broken line and a full line illustrated in an upper graph of the figure are the first lens apodization and the second lens apodization, respectively. The difference distribution between the distribution represented by the full line and the distribution represented by the broken line is calculated at Step S32. A full line illustrated in a lower graph of the figure is the second lens apodization the same as illustrated in the upper graph. A broken line illustrated in the lower graph is the lens apodization in the exposure apparatus 10 when the pellicle with a value decided at Step S33 in the thickness is used as the pellicle film 33. In this manner, the exposure apparatus 10 obtains the lens apodization closer to the second lens apodization by adjusting the thickness of the pellicle film 33 to such a value that the difference distribution between the first lens apodization and the second lens apodization can be offset. It is allowable to adjust the refractive index of the material making the pellicle film 33 instead of the thickness of the pellicle film 33 as the properties of the pellicle film 33 at Step S33. As the properties of the pellicle film 33, at least one between the film thickness and the refractive index of the material making the pellicle film 33 is selectable.

A pellicle having the properties decided at Step S33 is formed on the reticle 13 as the pellicle film 33 at Step S34. The exposure is performed via the reticle 13 including the pellicle film 33 that is formed at Step S34, at Step S35. The exposure is performed via the pellicle film 33 having the properties decided at Step S33, at Step S35. Thus, the exposure process goes to end. In the third embodiment, the mask patterns 32 formed on the reticle 13 can be projected in the high-resolution and high-precision manner. Moreover, because the reticle that is fabricated based on the OPC model the same as is used for the exposure apparatus is available as the reticle 13, the required time to prepare the reticle 13 is shorten. The drop in the required time to prepare the reticle 13 makes it possible to reduce the fabrication costs of the semiconductor device.

Although the properties of the pellicle film 33 are decided based on the lens apodization of the projection lens 15 in the exposure process according to the third embodiment, it is allowable to decide the properties based on some other factors such as the imaging properties. The imaging properties include, for example, the dimension error of the image that is projected through the projection lens 15. The dimension error depends on degree of the density, cycle, size of the mask patterns 32, etc. In this case, the mask patterns 32 can also be projected in the high-resolution and high-precision manner by adjusting the properties of the pellicle film 33.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of measuring a wavefront error of an exposure light that occurs when the exposure light passes through an optical system that is used in an exposure apparatus, the method comprising:
measuring the wavefront error of the exposure light by using a measurement optical element including a pellicle arranged in an optical path of the exposure light that passes through the optical system.

2. The method according to claim 1, wherein the measurement optical element includes
an aperture plate having an aperture through which the exposure light can pass; and
the pellicle that is arranged on an exit surface of the aperture plate.

3. The method according to claim 1, wherein the measuring includes measuring the wavefront error based on a result of imaging performed by using an imaging device that includes a plurality of light-receiving elements.

4. A method of correcting a wavefront error of an exposure light that occurs when the exposure light passes through an optical system that is used in an exposure apparatus, the method comprising:
acquiring a third wavefront error as a combined error of a first wavefront error and a second wavefront error,
the first wavefront error being a wavefront error occurring due to a projection optical system that is used to project an image having a predetermined pattern, and
the second wavefront error being a wavefront error occurring due to a pellicle that is arranged in an optical path of the exposure light; and
adjusting the projection optical system based on the third wavefront error.

5. The method according to claim 4, further comprising measuring the third wavefront error by using a measurement optical member including the pellicle.

6. The method according to claim 4, wherein the acquiring includes
measuring the first wavefront error;
calculating the second wavefront error that is expected to occur when the pellicle is arranged in an optical path of an exposure light; and
calculating the third wavefront error by combining the first wavefront error and the second wavefront error.

7. The method according to claim 6, wherein the calculating the second wavefront error includes assuming thickness of the pellicle to be an average value of a range of a manufacturing error and calculating the second wavefront error by using assumed thickness of the pellicle as a parameter.

8. The method according to claim 5, wherein the measuring the third wavefront error includes measuring the third wavefront error by using a measurement optical member that includes
an aperture plate having an aperture through which the exposure light can pass; and
the pellicle that is arranged on an exit surface of the aperture plate.

9. The method according to claim 5, wherein the measuring the third wavefront error includes calculating the third wavefront error based on a result of imaging performed by using an imaging device that includes a plurality of light-receiving elements.

10. A method of fabricating a semiconductor device by projecting an image having a predetermined pattern that is formed on a reticle onto a process object via a pellicle that is arranged on the reticle and a projection optical system, the method comprising:
acquiring a third wavefront error as a combined error of a first wavefront error and a second wavefront error,
the first wavefront error being a wavefront error occurring due to the projection optical system, and
the second wavefront error being a wavefront error occurring due to the pellicle; and
adjusting the projection optical system based on the third wavefront error.

11. The method according to claim 10, further comprising measuring the third wavefront error by using a measurement optical member including a pellicle having properties same as the pellicle that is arranged on the reticle.

12. The method according to claim 10, wherein the acquiring includes
measuring the first wavefront error;
calculating the second wavefront error that is expected to occur when the pellicle is arranged in an optical path of an exposure light; and
calculating the third wavefront error by combining the first wavefront error and the second wavefront error.

13. The method according to claim 12, wherein the calculating the second wavefront error includes assuming thickness of the pellicle to be an average value of a range of a manufacturing error and calculating the second wavefront error by using assumed thickness of the pellicle as a parameter.

14. The method according to claim 11, wherein the measuring the third wavefront error includes measuring the third wavefront error by using a measurement optical member that includes
an aperture plate having an aperture through which the exposure light can pass; and
the pellicle that is arranged on an exit surface of the aperture plate.

15. The method according to claim 11, wherein the measuring the third wavefront error includes calculating the third wavefront error based on a result of imaging performed by using an imaging device that includes a plurality of light-receiving elements.

16. The method according to claim 10, further comprising:
acquiring an optical property of an exposure apparatus as a first optical property;
acquiring difference between the first optical property and a second optical property, the second optical property being specified as a target of the optical property; and
deciding a property of the pellicle based on the difference.

17. The method according to claim 16, wherein the optical property includes lens apodization of the projection optical system.

18. The method according to claim 17, wherein the deciding includes setting a thickness of the pellicle to such a thickness that the difference between a first lens apodization as the first optical property and a second lens apodization as the second optical property can be offset.

19. The method according to claim 17, wherein the deciding includes selecting a material of the pellicle having a refractive index such that the difference between a first lens apodization as the first optical property and a second lens apodization as the second optical property can be offset.

20. The method according to claim 16, wherein the optical property is an imaging property of the projection optical system.
